(19) United States
(12) Patent Application Publication
(10) Pub. No.: US 2025/0048348 A1
(43) Pub. Date: Feb. 6, 2025

(54) REFERENCE SIGNAL FOR INITIAL BEAM-PAIRING WITH RESOURCE COORDINATION AMONG USER EQUIPMENTS

(71) Applicant: QUALCOMM Incorporated, San Diego, CA (US)

(72) Inventors: Kazuki TAKEDA, Minato-ku (JP); Sony AKKARAKARAN, Poway, CA (US); Hua WANG, Basking Ridge, NJ (US); Jelena DAMNJANOVIC, Del Mar, CA (US)

(21) Appl. No.: 18/363,636

(22) Filed: Aug. 1, 2023

(51) Int. Cl. H04W 72/044; H04W 72/20

(52) U.S. Cl. CPC H04W 72/046; H04W 72/20

(57) ABSTRACT

Various aspects of the present disclosure generally relate to wireless communication. In some aspects, a first user equipment (UE) may transmit a reference signal (RS) for initial beam-pairing (IBP) on an IBP-RS resource specific to transmission of the RS for IBP. The UE may receive, from a second UE, a beam-pairing response associated with the RS for IBP. Numerous other aspects are described.

### FIELD OF THE DISCLOSURE

Aspects of the present disclosure generally relate to wireless communication and to techniques and apparatuses for reference signal for initial beam-pairing with resource coordination among user equipments.

### DESCRIPTION OF RELATED ART

Wireless communication systems are widely deployed to provide various telecommunication services such as telephony, video, data, messaging, and broadcasts. Typical wireless communication systems may employ multiple-access technologies capable of supporting communication with multiple users by sharing available system resources (for example, bandwidth, transmit power, etc.). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

These multiple access technologies have been adopted in various telecommunication standards to provide a common protocol that enables different UEs to communicate on a municipal, national, regional, or global level. New Radio (NR), which also may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency-division multiplexing (OFDM) with a cyclic prefix (CP) (CP-OFDM) on the downlink, using CP-OFDM or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation.

### SUMMARY

In some aspects, an apparatus for wireless communication at a first user equipment (UE) includes one or more memories; and one or more processors, coupled to the one or more memories, individually or collectively configured to cause the first UE to: transmit a reference signal (RS) for initial beam-pairing (IBP) on an IBP-RS resource specific to transmission of the RS for IBP; and receive, from a second UE, a beam-pairing response associated with the RS for IBP.

In some aspects, an apparatus for wireless communication at a second UE includes one or more memories; and one or more processors, coupled to the one or more memories, configured to cause the UE to: receive an RS for IBP on an IBP-RS resource specific to transmission of the RS for IBP; and transmit, to a first UE, a beam-pairing response associated with the RS for IBP.

In some aspects, a method of wireless communication performed by a first UE includes transmitting an RS for IBP on an IBP-RS resource specific to transmission of the RS for IBP; and receiving, from a second UE, a beam-pairing response associated with the RS for IBP.

In some aspects, a method of wireless communication performed by a second UE includes receiving an RS for IBP on an IBP-RS resource specific to transmission of the RS for IBP; and transmitting, to a first UE, a beam-pairing response associated with the RS for IBP.

In some aspects, a non-transitory computer-readable medium storing a set of instructions for wireless communication includes one or more instructions that, when executed by one or more processors of a first UE, cause the first UE to: transmit an RS for IBP on an IBP-RS resource specific to transmission of the RS for IBP; and receive, from a second UE, a beam-pairing response associated with the RS for IBP.

In some aspects, a non-transitory computer-readable medium storing a set of instructions for wireless communication includes one or more instructions that, when executed by one or more processors of a second UE, cause the second UE to: receive an RS for IBP on an IBP-RS resource specific to transmission of the RS for IBP; and transmit, to a first UE, a beam-pairing response associated with the RS for IBP.

In some aspects, a first apparatus for wireless communication includes means for transmitting an RS for IBP on an IBP-RS resource specific to transmission of the RS for IBP; and means for receiving, from a second apparatus, a beam-pairing response associated with the RS for IBP.

In some aspects, a second apparatus for wireless communication includes means for receiving an RS for IBP on an IBP-RS resource specific to transmission of the RS for IBP; and means for transmitting, to a first apparatus, a beam-pairing response associated with the RS for IBP.

Aspects generally include a method, apparatus, system, computer program product, non-transitory computer-readable medium, user equipment, base station, network entity, network node, wireless communication device, and/or processing system as substantially described herein with reference to and as illustrated by the drawings.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network.

FIG. 2 is a diagram illustrating an example of a network node in communication with a user equipment (UE) in a wireless network.

FIG. 3 is a diagram illustrating an example disaggregated base station architecture, in accordance with the present disclosure.

FIG. 4 is a diagram illustrating an example of establishing an initial beam-pair (IBP), in accordance with the present disclosure.

FIG. 5 is a diagram illustrating an example of a unicast link establishment procedure, in accordance with the present disclosure.

FIG. 6 is a diagram illustrating an example of signaling associated with initial beam-pairing (IBP), in accordance with the present disclosure.

FIG. 7 is a diagram illustrating an example of a sidelink resource pool indicating IBP reference signal (IBP-RS) resources, in accordance with the present disclosure.

FIG. 8 is a diagram illustrating an example of selecting an IBP reference signal (IBP-RS) resource and scrambling an RS for IBP based at least in part on an identifier, in accordance with the present disclosure.

FIG. 9 is a diagram illustrating an example of identification of candidate IBP-RS resources, in accordance with the present disclosure.

FIG. 10 is a diagram illustrating an example of a first part and a second part of an RS for IBP, in accordance with the present disclosure.

FIG. 11 is a diagram illustrating an example of an implementation of the first part and the second part of an RS for IBP, in accordance with the present disclosure.

FIG. 12 is a diagram illustrating an example process performed, for example, at a UE or an apparatus of a UE, in accordance with the present disclosure.

FIG. 13 is a diagram illustrating an example process performed, for example, at a second UE or an apparatus of a second UE, in accordance with the present disclosure.

FIG. 14 is a diagram of an example apparatus for wireless communication, in accordance with the present disclosure.

FIG. 15 is a diagram of an example apparatus for wireless communication, in accordance with the present disclosure.

### DETAILED DESCRIPTION

Two or more user equipments (UEs) may communicate directly with one another using sidelink technology. Sidelink technology may involve communication between UEs without such communications passing via a radio access network. Some sidelink deployments may support beamformed communication, thereby improving gain of sidelink communication, which is particularly useful for UEs that generally have lower transmit power capabilities than network nodes. In such deployments, the process of establishing communication between two UEs may include initial beam-pairing (IBP), in which a first UE (transmitting (Tx) UE) and a second UE (receiving (Rx) UE) identify a suitable beam-pair for communication with one another.

A UE may transmit a reference signal (RS) for IBP to facilitate identification of beams for sidelink communication, such as sidelink unicast communication. However, transmission of the RS for IBP may occur before exchange of information between the UEs, since the RS for IBP may be transmitted prior to sidelink unicast link establishment. Therefore, there may be ambiguity regarding a resource for an RS for IBP (referred to herein as an IBP-RS resource) since the UEs may not explicitly signal information indicating the IBP-RS resource, which may lead to failure to select a suitable beam-pair, thereby impeding beamforming in sidelink communications. Furthermore, there may be risk of an RS for IBP colliding with a channel or resource, such as a sidelink data channel or feedback channel, which leads to degradation of performance of the RS for IBP and the colliding channel or resource. Still further, in some examples, a receiving UE may perform blind detection of the RS for IBP. Without a common understanding of candidate locations of an IBP-RS, delay and overhead may be incurred in blindly detecting an RS for IBP.

Various aspects relate generally to reference signaling for IBP. Some aspects more specifically relate to an IBP-RS resource for transmission of an RS for IBP. In some examples, the RS for IBP is known to a first UE and to a second UE, which reduces ambiguity regarding the RS for IBP, thereby improving beamforming and IBP selection. In some examples, the IBP-RS resource corresponds to a sidelink resource pool that indicates IBP-RS resources. For example, the sidelink resource pool may be configured so that the IBP-RS resources do not collide with another channel or resource. Some aspects of the present disclosure provide down-selection of a set of candidate IBP-RS resources, such that a receiving UE can perform blind detection on a reduced set of candidate IBP-RS resources.

Particular aspects of the subject matter described in this disclosure can be implemented to realize one or more of the following potential advantages. In some examples, by using an IBP-RS resource from a sidelink resource pool that identifies IBP-RS resources, the described techniques can be used to reduce or eliminate collision with other channels or signals. In some examples, by performing blind detection on a reduced set of candidate IBP-RS resources, delay and overhead in blind detection are reduced.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

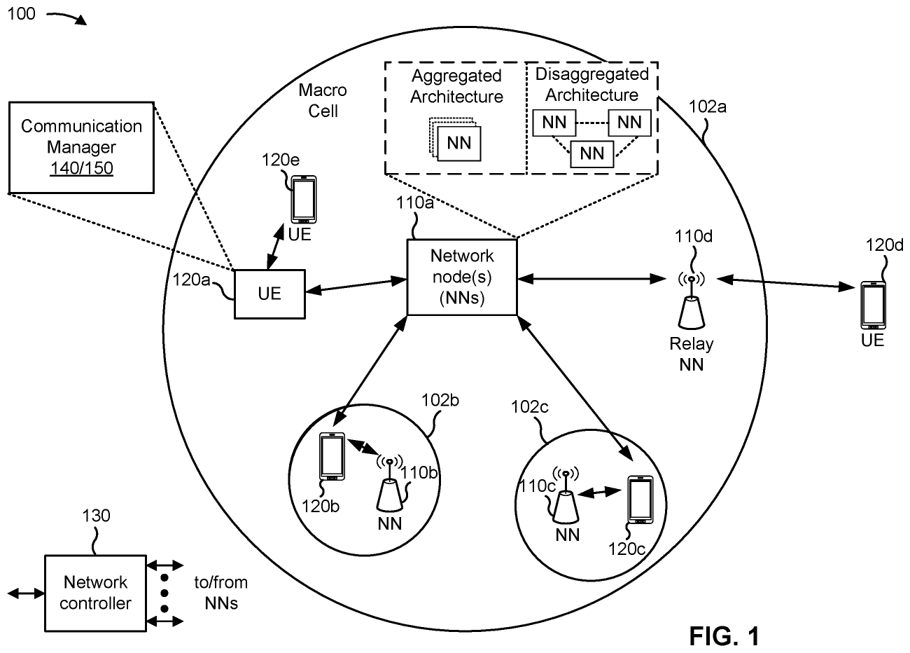

FIG. 1 is a diagram illustrating an example of a wireless network 100. The wireless network 100 may be or may include elements of a 5G (for example, NR) network or a 4G (for example, Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), or other entities. A network node 110 is an example of a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single RAN node (for example, within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUS)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (for example, in 4G), a gNB (for example, in 5G), an access point, or a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 or a network node subsystem serving this coverage area, depending on the context in which the term is used. A network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (for example, three) cells. In some examples, a cell may not necessarily be stationary, and the geographic area of the cell may move according to the location of a network node 110 that is mobile (for example, a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (for example, a network node 110 or a UE 120) and send a transmission of the data to a downstream node (for example, a UE 120 or a network node 110). A relay station may be a UE 120 that can relay transmissions for other UEs 120. In the example shown in FIG. 1, the network node 110d (for example, a relay network node) may communicate with the network node 110a (for example, a macro network node) and the UE 120d in order to facilitate communication between the network node 110a and the UE 120d. A network node 110 that relays communications may be referred to as a relay station, a relay base station, a relay network node, a relay node, or a relay, among other examples.

The wireless network 100 may be a heterogeneous network that includes network nodes 110 of different types, such as macro network nodes, pico network nodes, femto network nodes, or relay network nodes. These different types of network nodes 110 may have different transmit power levels, different coverage areas, or different impacts on interference in the wireless network 100. For example, macro network nodes may have a high transmit power level (for example, 5 to 40 watts) whereas pico network nodes, femto network nodes, and relay network nodes may have lower transmit power levels (for example, 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, or a subscriber unit. A UE 120 may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, smart jewelry (for example, a smart ring or a smart bracelet)), an entertainment device (for example, a music device, a video device, or a satellite radio), a vehicular component or sensor, a smart meter/sensor, industrial manufacturing equipment, a global positioning system device, a UE function of a network node, or any other suitable device that is configured to communicate via a wireless or wired medium.

Some UEs 120 may be considered machine-type communication (MTC) or evolved or enhanced machine-type communication (eMTC) UEs. An MTC UE or an eMTC UE may include, for example, a robot, an unmanned aerial vehicle, a remote device, a sensor, a meter, a monitor, or a location tag, that may communicate with a network node, another device (for example, a remote device), or some other entity. Some UEs 120 may be considered Internet-of-Things (IoT) devices, or may be implemented as NB-IoT (narrowband IoT) devices. Some UEs 120 may be considered a Customer Premises Equipment. A UE 120 may be included inside a housing that houses components of the UE 120, such as processor components or memory components. In some examples, the processor components and the memory components may be coupled together. For example, the processor components (for example, one or more processors) and the memory components (for example, a memory) may be operatively coupled, communicatively coupled, electronically coupled, or electrically coupled.

In general, any number of wireless networks 100 may be deployed in a given geographic area. Each wireless network 100 may support a particular RAT and may operate on one or more frequencies. A RAT may be referred to as a radio technology or an air interface. A frequency may be referred to as a carrier or a frequency channel. Each frequency may support a single RAT in a given geographic area in order to avoid interference between wireless networks of different RATs. In some cases, NR or 5G RAT networks may be deployed.

In some examples, two or more UEs 120 (for example, shown as UE 120a and UE 120e) may communicate directly using one or more sidelink channels (for example, without using a network node 110 as an intermediary to communicate with one another). For example, the UEs 120 may communicate using peer-to-peer (P2P) communications, device-to-device (D2D) communications, a vehicle-to-everything (V2X) protocol (for example, which may include a vehicle-to-vehicle (V2V) protocol, a vehicle-to-infrastructure (V2I) protocol, or a vehicle-to-pedestrian (V2P) protocol), or a mesh network. In such examples, a UE 120 may perform scheduling operations, resource selection operations, or other operations described elsewhere herein as being performed by the network node 110.

Devices of the wireless network 100 may communicate using the electromagnetic spectrum, which may be subdivided by frequency or wavelength into various classes, bands, or channels. For example, devices of the wireless network 100 may communicate using one or more operating bands. In 5G NR, two initial operating bands have been identified as frequency range designations FR1 (410 MHz-7.125 GHz) and FR2 (24.25 GHZ-52.6 GHz). Although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics or FR2 characteristics, and thus may effectively extend features of FR1 or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHZ), FR4 (52.6 GHz-114.25 GHZ), and FR5 (114.25 GHZ-300 GHz). Each of these higher frequency bands falls within the EHF band.

With these examples in mind, unless specifically stated otherwise, the term “sub-6 GHZ,” if used herein, may broadly represent frequencies that may be less than 6 GHz, may be within FR1, or may include mid-band frequencies. Further, unless specifically stated otherwise, the term “millimeter wave,” if used herein, may broadly represent frequencies that may include mid-band frequencies, may be within FR2, FR4, FR4-a or FR4-1, or FR5, or may be within the EHF band. It is contemplated that the frequencies included in these operating bands (for example, FR1, FR2, FR3, FR4, FR4-a, FR4-1, or FR5) may be modified, and techniques described herein are applicable to those modified frequency ranges.

In some aspects, a first UE (e.g., a UE 120) may include a communication manager 140. As described in more detail elsewhere herein, the communication manager 140 may transmit a reference signal (RS) for initial beam-pairing (IBP) on an IBP-RS resource specific to transmission of the RS for IBP; and receive, from a second UE, a beam-pairing response associated with the RS for IBP. Additionally, or alternatively, the communication manager 140 may perform one or more other operations described herein.

In some aspects, a second UE (e.g., a UE 120) may include a communication manager 140. As described in more detail elsewhere herein, the communication manager 140 may receive an RS for IBP on an IBP-RS resource specific to transmission of the RS for IBP; and transmit, to a first UE, a beam-pairing response associated with the RS for IBP. Additionally, or alternatively, the communication manager 140 may perform one or more other operations described herein.

As indicated above, FIG. 1 is provided as an example. Other examples may differ from what is described with regard to FIG. 1.

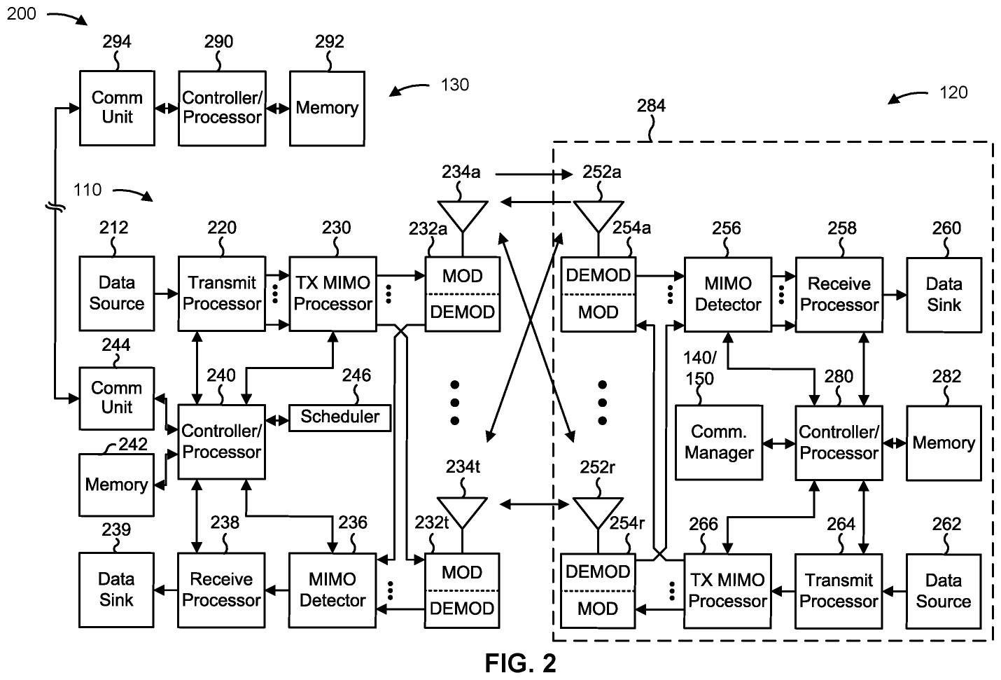

FIG. 2 is a diagram illustrating an example 200 of a network node 110 in communication with a UE 120 in a wireless network 100. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 using one or more channel quality indicators (CQIs) received from that UE 120. The network node 110 may process (for example, encode and modulate) the data for the UE 120 using the MCS(s) selected for the UE 120 and may provide data symbols for the UE 120. The transmit processor 220 may process system information (for example, for semi-static resource partitioning information (SRPI)) and control information (for example, CQI requests, grants, or upper layer signaling) and provide overhead symbols and control symbols. The transmit processor 220 may generate reference symbols for reference signals (for example, a cell-specific reference signal (CRS) or a demodulation reference signal (DMRS)) and synchronization signals (for example, a primary synchronization signal (PSS) or a secondary synchronization signal (SSS)). A transmit (TX) multiple-input multiple-output (MIMO) processor 230 may perform spatial processing (for example, precoding) on the data symbols, the control symbols, the overhead symbols, or the reference symbols, if applicable, and may provide a set of output symbol streams (for example, T output symbol streams) to a corresponding set of modems 232 (for example, T modems), shown as modems 232a through 232t. For example, each output symbol stream may be provided to a modulator component (shown as MOD) of a modem 232. Each modem 232 may use a respective modulator component to process a respective output symbol stream (for example, for OFDM) to obtain an output sample stream. Each modem 232 may further use a respective modulator component to process (for example, convert to analog, amplify, filter, or upconvert) the output sample stream to obtain a downlink signal. The modems 232a through 232t may transmit a set of downlink signals (for example, T downlink signals) via a corresponding set of antennas 234 (for example, T antennas), shown as antennas 234a through 234t.

At the UE 120, a set of antennas 252 (shown as antennas 252a through 252r) may receive the downlink signals from the network node 110 or other network nodes 110 and may provide a set of received signals (for example, R received signals) to a set of modems 254 (for example, R modems), shown as modems 254a through 254r. For example, each received signal may be provided to a demodulator component (shown as DEMOD) of a modem 254. Each modem 254 may use a respective demodulator component to condition (for example, filter, amplify, downconvert, or digitize) a received signal to obtain input samples. Each modem 254 may use a demodulator component to further process the input samples (for example, for OFDM) to obtain received symbols. A MIMO detector 256 may obtain received symbols from the modems 254, may perform MIMO detection on the received symbols if applicable, and may provide detected symbols. A receive processor 258 may process (for example, demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (for example, antennas 234a through 234t or antennas 252a through 252r) may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled to one or more transmission or reception components, such as one or more components of FIG. 2.

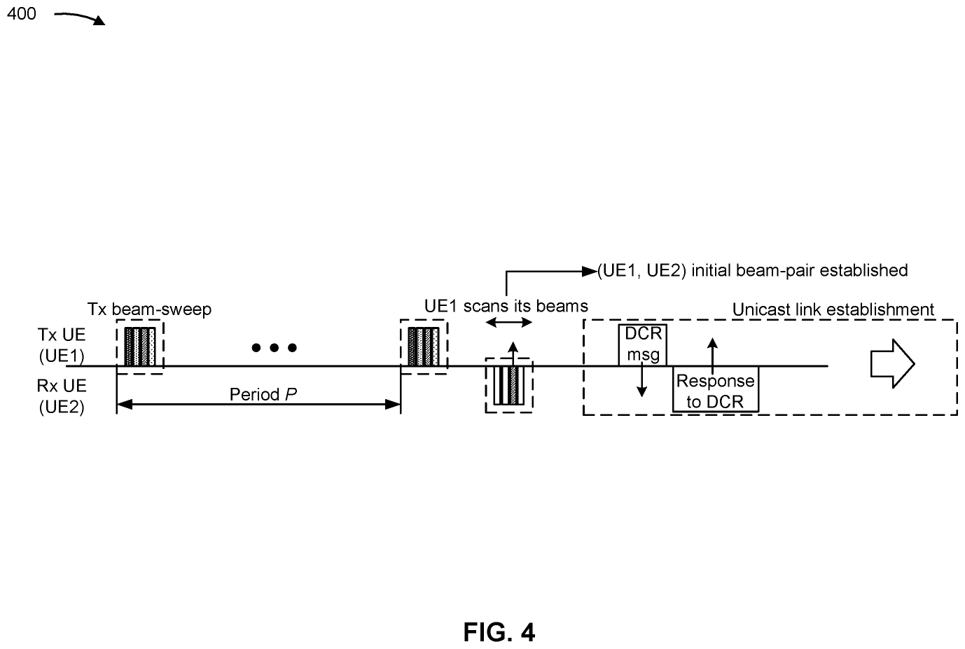

On the uplink, at the UE 120, a transmit processor 264 may receive and process data from a data source 262 and control information (for example, for reports that include RSRP, RSSI, RSRQ, or CQI) from the controller/processor 280. The transmit processor 264 may generate reference symbols for one or more reference signals. The symbols from the transmit processor 264 may be precoded by a TX MIMO processor 266 if applicable, further processed by the modems 254 (for example, for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, or the TX MIMO processor 266. The transceiver may be used by a processor (for example, the controller/processor 280) and the memory 282 to perform aspects of any of the processes described herein (e.g., with reference to FIGS. 4-15).

At the network node 110, the uplink signals from UE 120 or other UEs may be received by the antennas 234, processed by the modem 232 (for example, a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, or the TX MIMO processor 230. The transceiver may be used by a processor (for example, the controller/processor 240) and the memory 242 to perform aspects of any of the processes described herein (e.g., with reference to FIGS. 4-15).

In some aspects, the controller/processor 280 may be a component of a processing system. A processing system may generally be a system or a series of machines or components that receives inputs and processes the inputs to produce a set of outputs (which may be passed to other systems or components of, for example, the UE 120). For example, a processing system of the UE 120 may be a system that includes the various other components or subcomponents of the UE 120.

The processing system of the UE 120 may interface with one or more other components of the UE 120, may process information received from one or more other components (such as inputs or signals), or may output information to one or more other components. For example, a chip or modem of the UE 120 may include a processing system, a first interface to receive or obtain information, and a second interface to output, transmit, or provide information. In some examples, the first interface may be an interface between the processing system of the chip or modem and a receiver, such that the UE 120 may receive information or signal inputs, and the information may be passed to the processing system. In some examples, the second interface may be an interface between the processing system of the chip or modem and a transmitter, such that the UE 120 may transmit information output from the chip or modem. A person having ordinary skill in the art will readily recognize that the second interface also may obtain or receive information or signal inputs, and the first interface also may output, transmit, or provide information.

In some aspects, the controller/processor 240 may be a component of a processing system. A processing system may generally be a system or a series of machines or components that receives inputs and processes the inputs to produce a set of outputs (which may be passed to other systems or components of, for example, the network node 110). For example, a processing system of the network node 110 may be a system that includes the various other components or subcomponents of the network node 110.

The processing system of the network node 110 may interface with one or more other components of the network node 110, may process information received from one or more other components (such as inputs or signals), or may output information to one or more other components. For example, a chip or modem of the network node 110 may include a processing system, a first interface to receive or obtain information, and a second interface to output, transmit, or provide information. In some examples, the first interface may be an interface between the processing system of the chip or modem and a receiver, such that the network node 110 may receive information or signal inputs, and the information may be passed to the processing system. In some examples, the second interface may be an interface between the processing system of the chip or modem and a transmitter, such that the network node 110 may transmit information output from the chip or modem. A person having ordinary skill in the art will readily recognize that the second interface also may obtain or receive information or signal inputs, and the first interface also may output, transmit, or provide information.

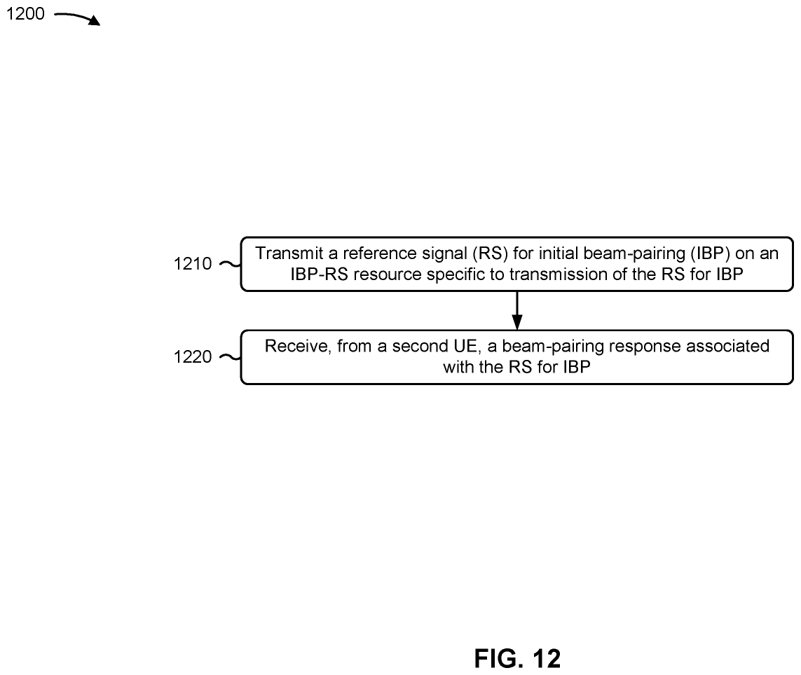

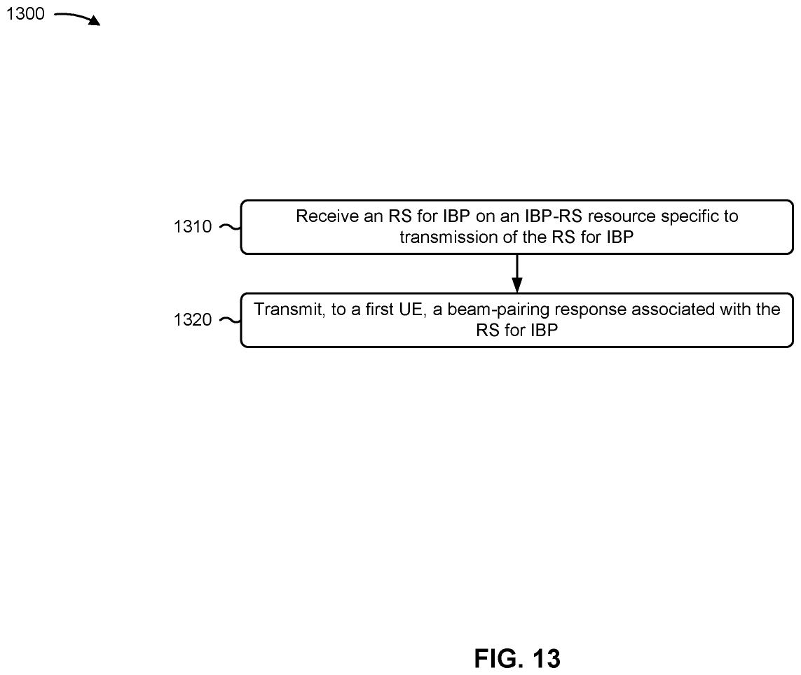

The controller/processor 240 of the network node 110, the controller/processor 280 of the UE 120, or any other component(s) of FIG. 2 may perform one or more techniques associated with IBP reference signaling, as described in more detail elsewhere herein. For example, the controller/processor 240 of the network node 110, the controller/processor 280 of the UE 120, or any other component(s) (or combinations of components) of FIG. 2 may perform or direct operations of, for example, process 1200 of FIG. 12, process 1300 of FIG. 13, and/or other processes as described herein. The memory 242 and the memory 282 may store data and program codes for the network node 110 and the UE 120, respectively. In some examples, the memory 242 and the memory 282 may include a non-transitory computer-readable medium storing one or more instructions (for example, code or program code) for wireless communication. For example, the one or more instructions, when executed (for example, directly, or after compiling, converting, or interpreting) by one or more processors of the network node 110 or the UE 120, may cause the one or more processors, the UE 120, or the network node 110 to perform or direct operations of, for example, process 1200 of FIG. 12, process 1300 of FIG. 13, and/or other processes as described herein. In some examples, executing instructions may include running the instructions, converting the instructions, compiling the instructions, and/or interpreting the instructions, among other examples.

In some aspects, a first UE 120 includes means for transmitting an RS for IBP on an IBP-RS resource specific to transmission of the RS for IBP; and/or means for receiving, from a second UE 120, a beam-pairing response associated with the RS for IBP. The means for the first UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a second UE 120 includes means for receiving an RS for IBP on an IBP-RS resource specific to transmission of the RS for IBP; and/or means for transmitting, to a first UE 120, a beam-pairing response associated with the RS for IBP. The means for the second UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (for example, within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

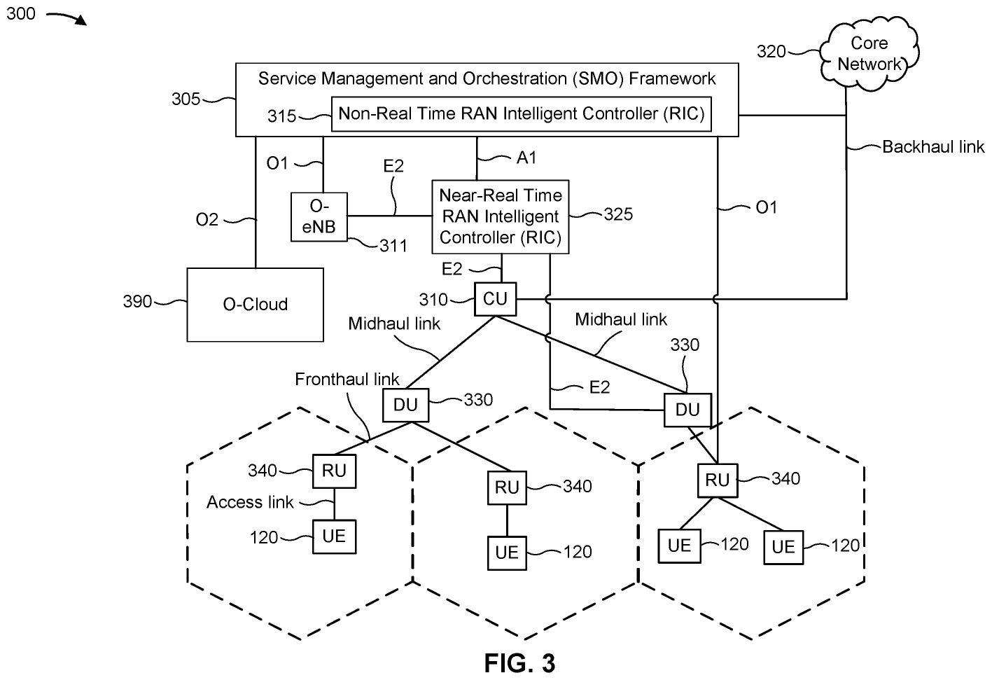

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as a RF transceiver), configured to receive or transmit signals, or both, over a wireless transmission medium to one or more of the other units.

In some aspects, the CU 310 may host one or more higher layer control functions. Such control functions can include radio resource control functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

FIG. 4 is a diagram illustrating an example 400 of establishing an initial beam-pair (IBP), in accordance with the present disclosure. An IBP includes a beam generated by a first UE and a beam generated by a second UE. For example, the first UE may transmit a communication using a first beam (a transmit beam) of the IBP and the second UE may receive the communication using a second beam (a receive beam) of the IBP. IBP is part of sidelink beam management, which also includes beam maintenance and beam failure recovery. Communicating with beams on the sidelink may improve gain for UEs relative to pseudo-omnidirectional communication, which may involve the UEs radiating signals in a substantially omnidirectional fashion.

As shown in FIG. 4, a first UE (e.g., a Tx UE) may transmit a plurality of reference signals (RSs) for IBP via different Tx beams, which may be based at least in part on a Tx beam sweep. The first UE may repeat the Tx beam sweep according to a period P. A second UE may measure the plurality of RSs for IBP. The second UE may determine a first UE Tx beam and/or a second UE Rx beam, which may be based at least in part on measurements of the plurality of RSs for IBP. For example, the second UE may select the second UE Rx beam based at least in part on this beam having a best measurement (e.g., a highest signal strength) or a measurement that has a signal strength equal to or more than a threshold, and may select the first UE Tx beam based on the first UE Tx beam having a best measurement (e.g., a highest signal strength). The second UE may transmit, to the first UE, an indication of a determined first UE Tx beam and/or a determined second UE Rx beam, referred to herein as a beam-pairing response. The first UE may establish an IBP for the first UE and the second UE based at least in part on the indication. For example, the first UE may use the indicated first UE Tx beam, or may generate a beam using one or more parameters of the first UE Tx beam. During a unicast link establishment, the first UE may transmit an initiating message to the second UE, and the second UE may transmit a response to the first UE, where the initiating message and the response may be based at least in part on the IBP. For example, the first UE may transmit the initiating message using the first UE Tx beam (or a beam derived from the first UE Tx beam) and the second UE may transmit the response using a Tx beam derived from the second UE Rx beam. As another example, the first UE may receive the response using an Rx beam derived from the first UE Tx beam and the second UE may receive the initiating message using the second UE Rx beam (or a beam derived from the second UE Rx beam).

As mentioned, the first UE may transmit a plurality of RSs for IBP via different beams. An RS for IBP may include any suitable form of signal (examples are described herein). In some aspects, an RS for IBP may not provide time or frequency (time/frequency) synchronization, a master information block, or a system information block, which may improve efficiency of RS transmission. For example, the synchronization, master information block, and system information block may be provided by other means, such as a global navigation satellite system, a network node, or a synchronization reference UE. In some aspects, the RS for IBP, per Tx beam, may span a number (e.g., one or two) of consecutive OFDM symbols, which enables beam-sweeping in a short period of time, such that multiple RSs can be transmitted with different beams or beam-pairs within a slot. According to some techniques described herein, the RS for IBP may not be associated with a physical sidelink control channel (PSCCH) or a physical sidelink shared channel (PSSCH). For example, the RS for IBP may not be transmitted with sidelink control information (SCI), a sidelink medium access control control element (MAC-CE), or a sidelink data transmission. Thus, the RS for IBP may be considered standalone reference signals.

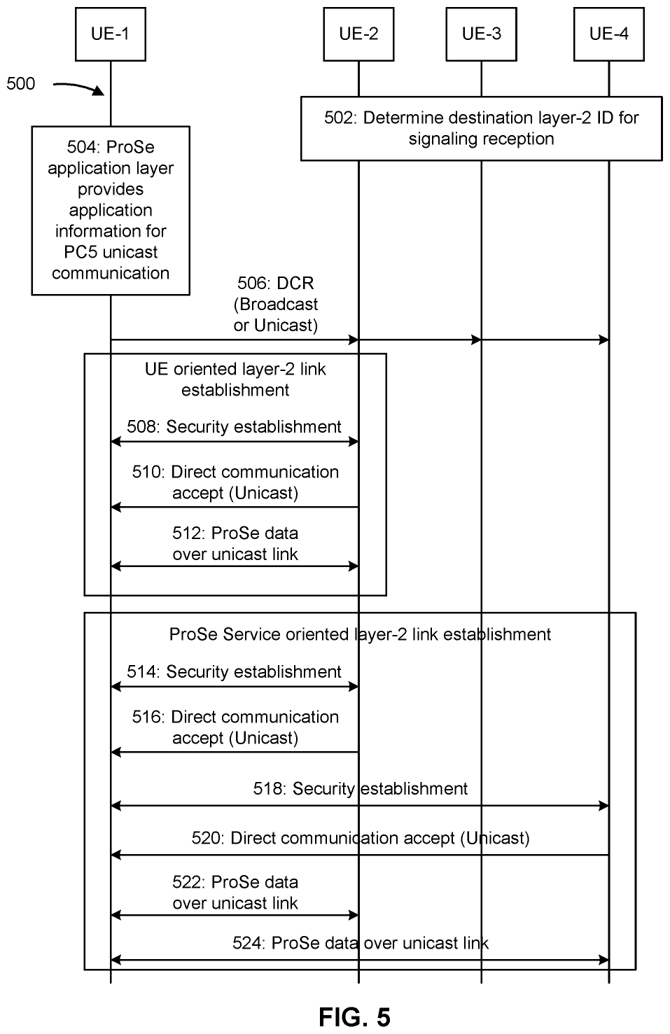

After performing IBP, the first UE and the second UE may proceed to unicast link establishment, as described with regard to FIG. 5.

As indicated above, FIG. 4 is provided as an example. Other examples may differ from what is described with regard to FIG. 4.

During a unicast link establishment procedure, a second UE (e.g., an Rx UE) may determine an identifier such as a destination layer-2 ID for a reception of a message for sidelink communication establishment carried by a physical sidelink shared channel (PSSCH) and a corresponding physical sidelink control channel (PSCCH), where the message may be a direct communication request (DCR) message. The identifier may include a target UE's layer-2 ID or a service identifier. A first UE (e.g., a Tx UE) may determine the destination layer-2 ID for a transmission of the DCR message. The first UE may self-assign a source layer-2 ID for the DCR message. For a response to the DCR message (e.g., a security establishment message), the second UE may set the destination layer-2 ID to the source layer-2 ID of a received DCR message. The first UE may obtain the second UE's layer-2 ID for subsequent communication with the second UE.

FIG. 5 is a diagram illustrating an example 500 of a unicast link establishment procedure, in accordance with the present disclosure. As shown in FIG. 5, example 500 includes communication between a first UE (UE-1), a second UE (UE-2), a third UE (UE-3), and a fourth UE (UE-4). In some aspects, the first UE, the second UE, the third UE, and the fourth UE may be included in a wireless network, such as wireless network 100.

As shown by reference number 502, the second UE, the third UE, and the fourth UE may determine a destination layer-2 ID for signaling reception, respectively. As shown by reference number 504, the first UE may provide, via a proximity services (ProSe) application layer, application information for a PC5 unicast communication. PC5 is an interface used for sidelink communication among UEs. As shown by reference number 506, the first UE may transmit a DCR message to the second UE, the third UE, and the fourth UE, respectively. The first UE may transmit the DCR message via a broadcast or a unicast. A UE (such as the second UE, the third UE, or the fourth UE) may respond to the first UE's DCR message if the UE is a target UE of the DCR message (such as if the DCR message identifies the UE) or the UE has an interest in direct communication with the first UE for a particular service.

As shown by reference number 508, during a UE-oriented layer-2 link establishment, the first UE and the second UE may perform a security establishment. As shown by reference number 510, the first UE may receive, from the second UE, a direct communication accept message via a unicast. As shown by reference number 512, the first UE and the second UE may establish a ProSe data over unicast link.

During a ProSe service oriented layer-2 link establishment, as shown by reference number 514, the first UE and the second UE may perform a security establishment. As shown by reference number 516, the first UE may receive, from the second UE, a direct communication accept message via a unicast. As shown by reference number 518, the first UE and the fourth UE may perform a security establishment. As shown by reference number 520, the first UE may receive, from the fourth UE, a direct communication accept message via a unicast. As shown by reference number 522, the first UE and the second UE may establish a ProSe data over unicast link. As shown by reference number 524, the first UE and the fourth UE may establish a ProSe data over unicast link.

As indicated above, FIG. 5 is provided as an example. Other examples may differ from what is described with regard to FIG. 5.

As mentioned, a UE may transmit an RS per Tx beam for IBP to facilitate identification of beams for sidelink communication, such as sidelink unicast communication. However, transmission of the RS for IBP may occur before exchange of information between the UEs, since the RS for IBP may be transmitted prior to the initiation or the completion of sidelink unicast link establishment. Therefore, there may be ambiguity regarding a resource for an RS for IBP (referred to herein as an IBP-RS resource) since the UEs may not explicitly signal information indicating the IBP-RS resource, which may lead to failure to select a suitable beam-pair, thereby impeding beamforming in sidelink communications. Furthermore, there may be risk of an RS for IBP colliding with a channel or resource, such as a sidelink data channel or feedback channel, which leads to degradation of performance of the RS for IBP and the colliding channel or resource. Still further, in some examples, a receiving UE may perform blind detection of the RS for IBP. Without a common understanding of candidate locations of an IBP-RS, delay and overhead may be incurred in blindly detecting an RS for IBP.

Various aspects relate generally to reference signaling for IBP. Some aspects more specifically relate to an IBP-RS resource for transmission of an RS for IBP. In some examples, the RS for IBP is known to a first UE and to a second UE, which reduces ambiguity regarding the RS for IBP, thereby improving beamforming and IBP selection. In some examples, the IBP-RS resource corresponds to a sidelink resource pool that indicates IBP-RS resources. For example, the sidelink resource pool may be configured so that the IBP-RS resources do not collide with another channel or resource. Some aspects of the present disclosure provide down-selection of a set of candidate IBP-RS resources, such that a receiving UE can perform blind detection on a reduced set of candidate IBP-RS resources.

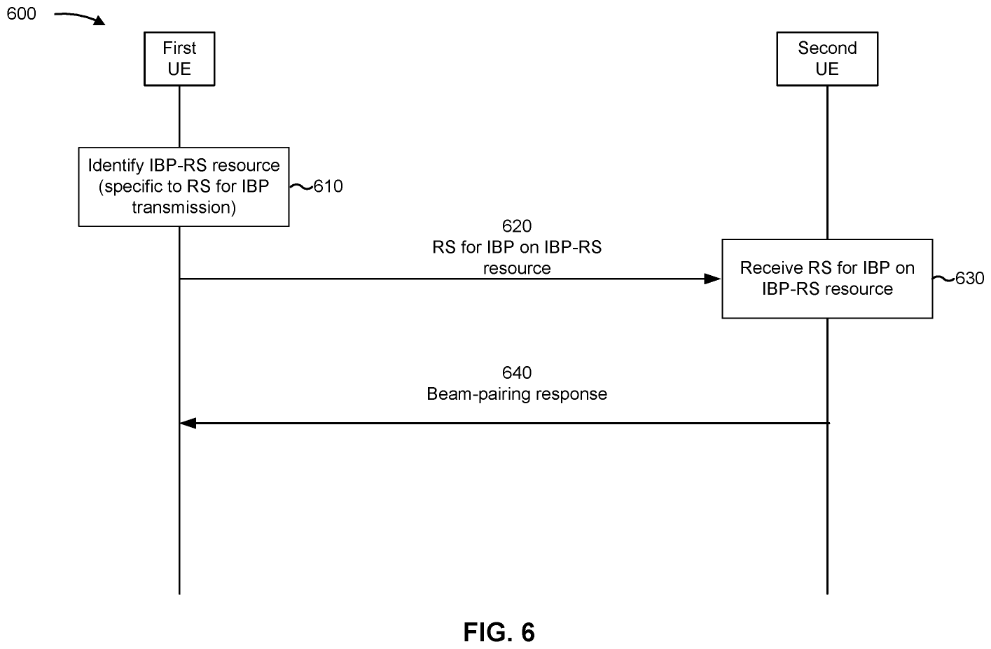

FIG. 6 is a diagram illustrating an example 600 of signaling associated with IBP, in accordance with the present disclosure. Example 600 includes a first UE (e.g., UE 120) and a second UE (e.g., UE 120). The first UE may be a Tx UE and the second UE may be an Rx UE. For example, the Tx UE may transmit an RS for IBP, and the Rx UE may receive the RS for IBP.

As shown by reference number 610, the first UE may identify an IBP-RS resource. The IBP-RS resource may be specific to transmission of RSs for IBPs. For example, the IBP-RS resource may be a standalone resource. A standalone resource may include a resource that is not associated with (e.g., overlapped with a resource for, transmitted via, or transmitted in a slot or a portion of a slot shared with) another channel or signal. For example, the time, frequency, and/or spatial resources of a standalone resource may be used solely for transmission of an RS for IBP. From the viewpoint of a UE receiving or monitoring the IBP-RS, the UE does not need to receive, decode, or monitor another channel or signal, when receiving or monitoring the IBP-RS. This can be contrasted with a non-standalone resource. A non-standalone resource may be associated with sidelink data transmission (such as transmission of a PSSCH), sidelink feedback transmission (such as transmission of a PSFCH), or sidelink control transmission (such as transmission of a PSCCH or sidelink control information (SCI)). If a non-standalone resource were used for transmission of an RS for IBP, the RS for IBP may, for example, be transmitted in the same slot or in a corresponding slot as an SCI format 1, an SCI format 2, a sidelink MAC-CE, or sidelink data. In some aspects, one or multiple of the SCI format 1, the SCI format 2, the sidelink MAC-CE, or sidelink data, may indicate or trigger the transmission of the associated IBP-RS for a non-standalone resource. From the viewpoint of a UE receiving or monitoring the IBP-RS on a non-standalone resource, the UE may not consider the IBP-RS to be transmitted unless the UE acquires an indication or trigger of the IBP-RS associated with one or multiple of the SCI format 1, the SCI format 2, the sidelink MAC-CE, or sidelink data. Thus, the IBP-RS resource may be specific to transmission of RSs for IBPs (e.g., a standalone resource) because the IBP-RS may occur in symbols in a slot, or may occupy symbols of a slot, in which other sidelink transmissions are not performed by the first UE, or may not be indicated or triggered by another sidelink transmission by the first UE.

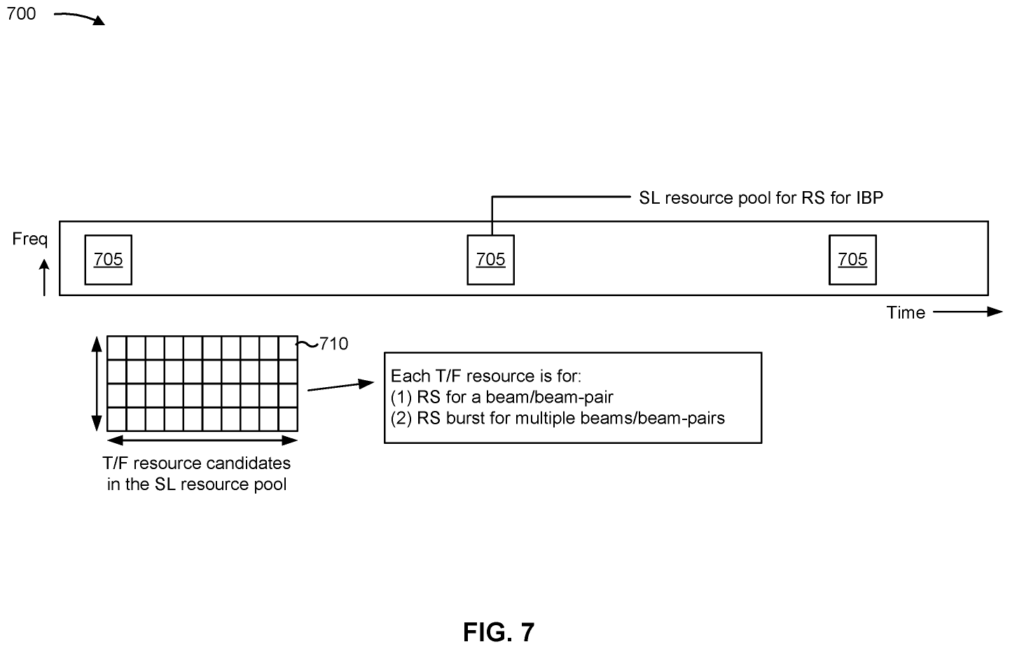

In some aspects, the IBP-RS resource may correspond to a sidelink resource pool. The sidelink resource pool may indicate one or more IBP-RS resources. FIG. 7 is a diagram illustrating an example 700 of a sidelink resource pool 705 indicating IBP-RS resources, in accordance with the present disclosure. The sidelink resource pool 705 may be associated with a periodicity that indicates how often instances of the sidelink resource pool 705 occur. The IBP-RS resources are shown by reference number 710. In example 700, the IBP-RS resources include a number of candidate IBP-RS resources. Each IBP-RS resource (e.g., candidate resource) may comprise a time resource and a frequency resource. In some aspects, an IBP-RS resource may be for an RS for a single beam or beam-pair. For example, the first UE may transmit an RS for IBP using a single beam or beam-pair on the IBP-RS resource. In some other aspects, an IBP-RS resource may be for an RS burst for multiple beams or multiple beam-pairs. For example, the first UE may transmit multiple RSs for IBP using different beams or beam-pairs on the IBP-RS resource.

In some aspects, the sidelink resource pool 705 may be configured. For example, the first UE and/or the second UE may receive (e.g., from a network node) configuration information indicating the sidelink resource pool 705. In some aspects, the sidelink resource pool 705 may be pre-configured, such as by a network operator or a service provider associated with the first UE or the second UE. In some aspects, parameters of the sidelink resource pool 705 may be specified in a wireless communication specification.

In some aspects, the IBP-RS resources of the sidelink resource pool 705 may be specific to transmission of RS for IBP. For example, the resources of the sidelink resource pool 705 may not be used for other purposes, such as sidelink data transmission.

Returning to FIG. 6, in some aspects, the first UE may select the IBP-RS resource from one or more candidate IBP-RS resources. In some aspects, the one or more candidate IBP-RS resources may include candidate IBP-RS resources of a sidelink resource pool (e.g., sidelink resource pool 705).

In some aspects, the first UE may select the IBP-RS resource based at least in part on an identifier, such as a destination identifier (e.g., a destination Layer-2 identifier). Additionally, or alternatively, the first UE may scramble a transmission of the RS for IBP based at least in part on the identifier. For example, a time/frequency resource in a sidelink resource pool, and an RS scrambling identifier for the RS for IBP (e.g., a periodic RS for IBP), may be derived from a value of a destination identifier used for initiating unicast link establishment.

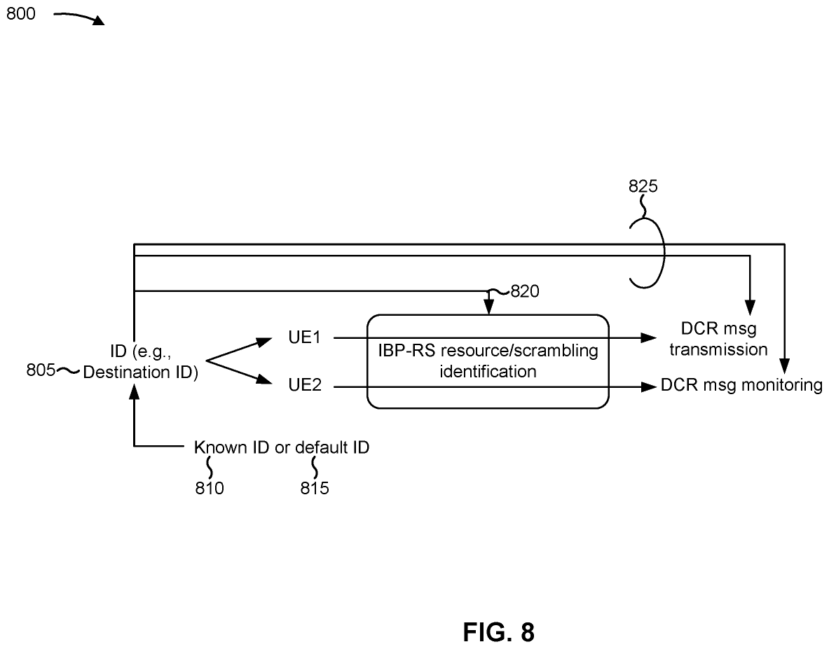

FIG. 8 is a diagram illustrating an example 800 of selecting an IBP-RS resource and scrambling an RS for IBP based at least in part on an identifier, in accordance with the present disclosure. As shown by reference number 805, in some aspects, the identifier (ID) may be a destination identifier, such as a destination identifier used to initiate a unicast link establishment procedure. As shown by reference number 810, in some aspects, the destination identifier may be a known identifier. For example, the first UE may use a Layer 2 identifier of the second UE to select the IBP-RS resource and/or scramble the RS for IBP, if the Layer 2 identifier of the second UE is known to the first UE. As shown by reference number 815, in some aspects, the destination identifier may be a default identifier. For example, the first UE may use a default identifier (such as a ProSe identifier) to select the IBP-RS resource and/or scramble the RS for IBP if the Layer 2 identifier is not known (e.g., if the second UE is not known to the first UE). The arrow 820 from “ID (e.g., destination ID)” to “IBP-RS resource/scrambling identification” indicates that the IBP-RS resource and/or the scrambling of the RS for IBP may be based at least in part on the identifier.

In some aspects, a scrambling ID or a sequence ID (scrambling/sequence ID) of the RS for IBP may be based at least in part on the destination ID. In some aspects, the destination ID may be used to derive the scrambling ID (n_{ID}) or the sequence ID of the IBP-RS. As an example, the IBP-RS may be a sidelink channel state information reference signal (CSI-RS). A pseudo-random sequence generator may be initialized with: cᵢₙᵢₜ=(2¹⁰(N_{symb}^{slot}n_{s,f}^{μ}+l+1)(2n_{ID}+1)+n_{ID})mod 2³¹, where cᵢₙᵢₜ is a seed value, N_{symb}^{slot} is a number of symbols per slot, n_{s,f}^{μ} is a slot number within a frame for subcarrier spacing configuration μ. l is the OFDM symbol number within a slot, and n_{ID}=N_{ID}^{X} mod 2¹⁰, where the quantity N_{ID}^{X} equals the decimal representation of a cyclic redundancy check (CRC) for SCI mapped to a PSCCH associated with a CSI-RS. Thus, N_{ID}^{X} may represent a total number of scrambling IDs that can be used for the RS for IBP. In the context of scrambling ID determination. N_{ID}^{X} may have a larger number of possible values than in the context of IBP-RS resource identification. For example, N_{ID}^{X} may be 2⁸, 21⁶, 2²⁴, 2³², etc. If N≥2²⁴, the scrambling ID can be unique to each destination ID (since the destination ID is 24 bits long). If N<2²⁴, multiple different destination IDs may be mapped to the same scrambling ID.

As shown by reference number 825, in some aspects, the first UE may transmit a DCR message based at least in part on the destination identifier. For example, the first UE may use a Layer 2 identifier of the second UE for a DCR message if the Layer 2 identifier is known to the first UE, or may use a default identifier (e.g., ProSe identifier, service identifier, or application identifier) for the DCR message if the Layer 2 identifier is not known to the first UE. The second UE may respond to the first UE's DCR message if a destination identifier of the DCR message is the second UE's Layer 2 identifier, or if the destination identifier is a ProSe identifier in which the second UE is interested.

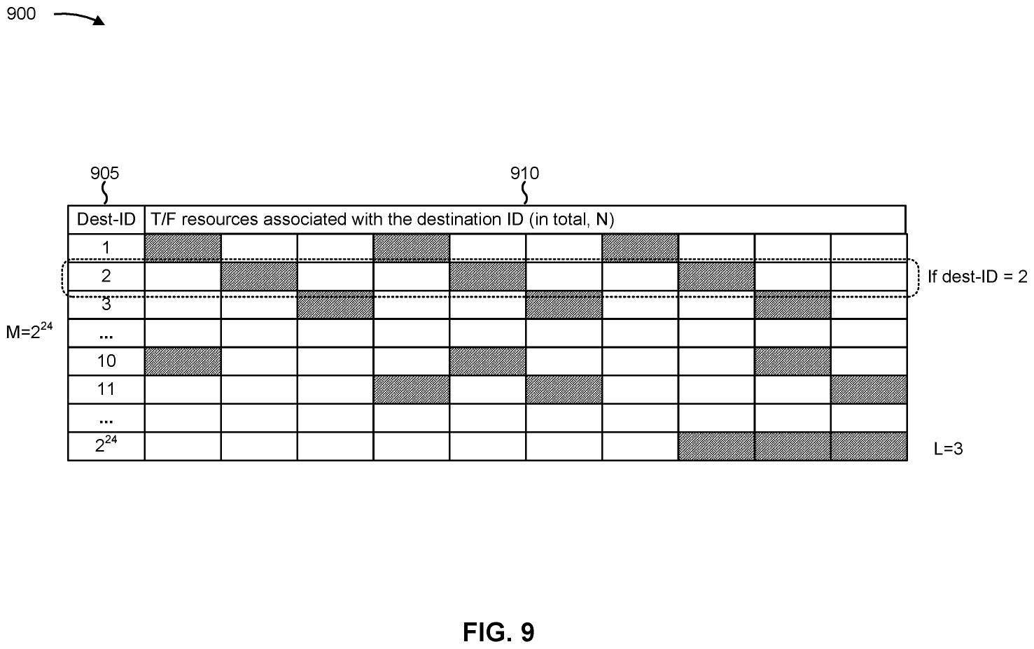

In some aspects, the first UE and/or the second UE may identify a set of candidate IBP-RS resources. For example, the first UE and/or the second UE may down-select the set of candidate IBP-RS resources from a plurality of candidate IBP-RS resources. FIG. 9 is a diagram illustrating an example 900 of identification of candidate IBP-RS resources, in accordance with the present disclosure. A column 905 indicates identifiers (e.g., destination identifiers). Reference number 910 illustrates a set of candidate IBP-RS resources that are mapped to each identifier. A set of candidate IBP-RS resources, mapped to each identifier, are indicated by a dark fill. Thus, different sets of IBP-RS resources, selected from a plurality of 10 IBP-RS resources, are mapped to the identifiers. A number of IBP-RS resources belonging to a set of IBP-RS resources may be referred to as L. In example 900, L is 3.

A first UE may not select IBP-RS resources that are not associated with (e.g., mapped to) the destination identifier of the unicast link establishment. As a result, the first UE can select IBP-RS resources from the L candidate IBP-RS resources associated with the destination identifier. From the L candidate IBP-RS resources in a set of candidate IBP-RS resources, the first UE may select an IBP-RS resource, and may transmit an RS for IBP on the selected IBP-RS resource. Thus, the first UE may select the IBP-RS resource based at least in part on the identifier, by identifying the L candidate IBP-RS resources using the identifier and then selecting the IBP-RS resource from the L candidate IBP-RS resources. In some aspects (whether or not down-selection of candidate IBP-RS resources is implemented), the first UE may perform random selection for the IBP-RS resource. For example, the first UE may randomly select an IBP-RS resource from the L IBP-RS resources. In some aspects (whether or not down-selection of candidate IBP-RS resources is implemented), the first UE may perform sensing-based selection for the IBP-RS resource (sometimes referred to as sensing based resource coordination). For example, the first UE may perform a measurement on the L IBP-RS resources, such as an RSRP measurement, an RSSI measurement, an energy measurement, or the like. The first UE may select an IBP-RS resource with a lowest measurement value, such as a lowest RSRP value. Additionally, or alternatively, the first UE may select an IBP-RS resource with a measurement value that is lower than a threshold. In some aspects, the first UE may be configured or pre-configured with information indicating whether to perform sensing-based selection or random selection. In some aspects, a wireless communication specification may indicate whether to perform sensing-based selection or random selection.

Returning to FIG. 6, and as shown by reference number 620, the first UE may transmit the RS for IBP using the IBP-RS resource. For example, the UE may transmit the RS for IBP using a single beam or using multiple beams. In some aspects, the first UE may transmit the RS for IBP using a scrambling identifier, which the first UE may identify based on an identifier (e.g., destination identifier, ProSe identifier, service identifier, or application identifier). In some aspects, the first UE may transmit the RS for IBP including a first part and a second part, as described below.

As shown by reference number 630, the second UE may receive the RS for IBP on the IBP-RS resource. For example, the second UE may detect or decode the RS for IBP. In some aspects, the second UE may perform blind detection or blind measurement to receive the RS for IBP. “Blind detection” or “blind measurement” may include attempting to receive a signal using multiple different hypotheses. A hypothesis may indicate a resource (e.g., a candidate IBP-RS resource), a parameter (e.g., a scrambling identifier), or a combination thereof. For example, a first hypothesis may correspond to a first IBP-RS resource and a first scrambling identifier, a second hypothesis may correspond to a second IBP-RS resource and the first scrambling identifier, and a third hypothesis may correspond to the second IBP-RS resource and a second scrambling identifier. The second UE may attempt to measure the signal strength of an RS for IBP at the first IBP-RS resource (e.g., using the first scrambling identifier), and at the second IBP-RS resource using the first scrambling identifier and the second scrambling identifier.

In some aspects, the second UE may use an identifier, such as a destination identifier of a unicast link establishment between the second UE and the first UE (or a ProSe identifier, a service identifier, or an application identifier), to identify candidate IBP-RS resources and a scrambling identifier for an RS for IBP. For example, the second UE may identify the candidate IBP-RS resources and the scrambling identifier in the same fashion as the first UE, as described in connection with FIG. 9 in the context of identifying the IBP-RS resource at the first UE. The second UE may perform blind detection on the identified candidate IBP-RS resources using the identified scrambling identifier. For example, the second UE may attempt to receive an RS for IBP by searching for RSs for IBP over the candidate IBP-RS resources and scrambling identifier identified by the destination identifier.

In some aspects, a UE may be associated with multiple identifiers. For example, the first UE may be associated with multiple services, and each of the multiple services may be associated with a respective identifier. In some aspects, the first UE may transmit RSs for IBP using the multiple identifiers. For example, the first UE may transmit multiple RSs for IBP, each RS for IBP associated with (e.g., generated using, having a scrambling identifier derived from) a respective identifier of the multiple identifier. A second UE may use multiple identifiers to monitor for an RS for IBP, as described elsewhere herein. For example, the second UE may monitor for the RS for IBP using each of multiple identifiers associated with the second UE.

As shown by reference number 640, the second UE may transmit a beam-pairing response to the first UE. The beam-pairing response may be based at least in part on the RS for IBP. For example, the beam-pairing response may indicate that the RS for IBP was received, one or more parameters associated with the RS for IBP, a selected beam, a selected beam-pair, measurement information regarding an RS for IBP, or the like. The beam-pairing response is described with regard to FIG. 4.

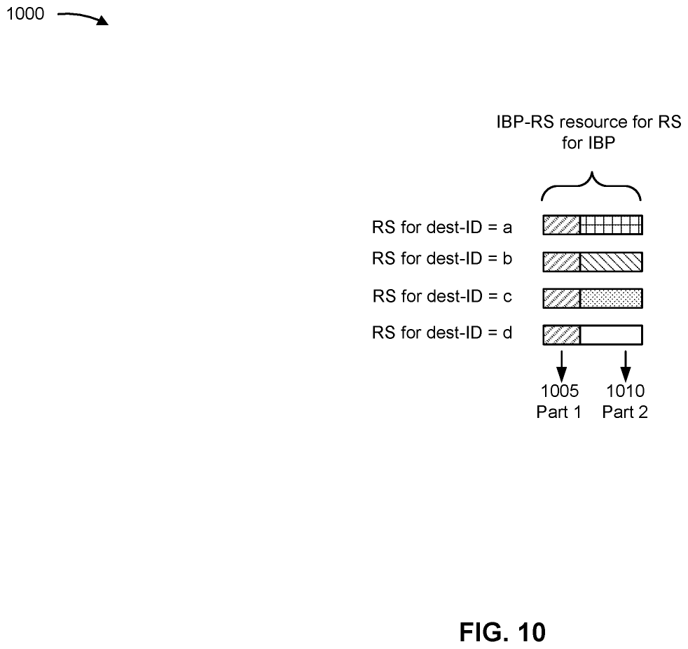

FIG. 10 is a diagram illustrating an example 1000 of a first part and a second part of an RS for IBP, in accordance with the present disclosure. The selection of IBP-RS resources and scrambling identifiers based on an identifier such as a destination identifier may simplify the second UE's behavior (by limiting the number of hypotheses for RS monitoring) and the first UE's resource selection and coordination for IBP. However, for sensing based resource coordination (e.g., selecting an IBP-RS resource based on sensing of an IBP-RS resource), Tx UEs may perform sensing using a number of hypotheses for the RS for IBP. For example, a candidate IBP-RS resource may be mapped to multiple (and potentially a large number of) destination identifiers. A first UE may perform resource sensing (e.g., RSRP measurement) to determine that a candidate IBP-RS resource is not used by other Tx UEs with various possible destination identifiers. RSRP measurement may involve the Tx UE measuring the RS with each potential scrambling identifier, which may involve complexity for resource sensing.

In some aspects, the first UE may perform a received signal strength indicator (RSSI) measurement or a received energy measurement on each candidate IBP-RS resource associated with a given identifier (e.g., destination identifier, ProSe identifier, service identifier, or application identifier). For example, the first UE may not use a scrambling identifier for measurement or sensing, which simplifies sensing. However, RSSI or energy measurement may be associated with a lower accuracy than sensing using a scrambling identifier.

Example 1000 is an example in which a design of the RS for IBP facilitates simplified monitoring of the RS for IBP. The RS for IBP includes a first part 1005 and a second part 1010. The first part 1005 may be considered a common part and the second part 1010 may be considered an individual part. The common part may be for a first set of identifiers, such as multiple identifiers (e.g., ProSe identifier, service identifier, destination identifier, or application identifier). For example, the common part may use a scrambling identifier (e.g., sequence) or resource that is common for multiple identifiers, indicated by each of the four RSs for IBP illustrated in FIG. 10 having a same fill in the first part 1005. Each identifier of the multiple identifiers may correspond to a first UE (such as in a one-to-one ratio, a one-to-many ratio, a many-to-one ratio, or a many-to-many ratio). For example, a first UE may be associated with an identifier based on the identifier identifying the first UE, a service of the first UE, an application of the first UE, or a destination of a communication or link of the first UE. The individual part may use a scrambling identifier (e.g., sequence) or resource that is specific to an identifier (e.g., ProSe identifier, service identifier, destination identifier, or application identifier). For example, each destination identifier corresponding to the common part may be associated with a different scrambling identifier in the individual part, indicated by each of the four RSs for IBP illustrated in FIG. 10 having different fills in the second part 1010.

In some aspects, the first part 1005 and the second part 1010 may occupy different time resources (e.g., of the same RS for IBP). For example, the first part 1005 may occupy a first time resource and the second part 1010 may occupy a second time resource different than the first time resource. Additionally, or alternatively, the first part 1005 and the second part 1010 may occupy different frequency resources (e.g., of the same RS for IBP). For example, the first part 1005 may occupy a first frequency resource and the second part 1010 may occupy a second frequency resource different than the first frequency resource.

A second UE (e.g., a receiving UE) may measure the RS for IBP based, at least in part, on the second part 1010. For example, the second UE may perform monitoring for the RS for IBP (as described in connection with FIGS. 6 and 9) using a destination identifier associated with the second UE. A first UE (e.g., a Tx UE) may perform sensing for the RS for IBP based at least in part on the first part 1005. This may enable the first UE to detect whether an IBP-RS resource is occupied by another first UE (e.g., another Tx UE), at a lower level of complexity than using a scrambling specific to various identifiers. For example, the first UE may perform sensing using a hypothesis corresponding to multiple identifiers (which may, for example, correspond to multiple first UEs). In some aspects, the first UE may also measure the second part 1010, which may improve accuracy of sensing.

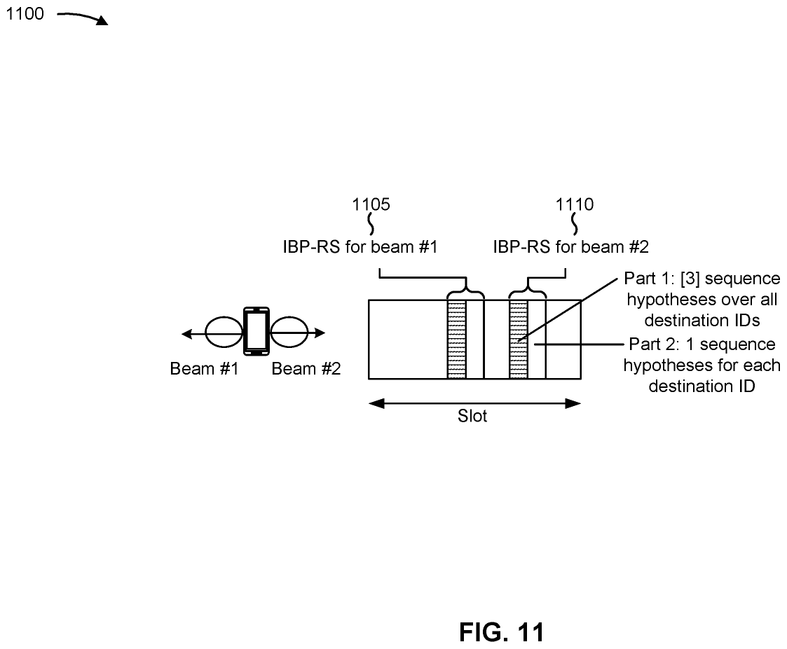

FIG. 11 is a diagram illustrating an example 1100 of an implementation of the first part 1005 and the second part 1010 of an RS for IBP, in accordance with the present disclosure. Example 1100 shows a first RS for IBP 1105 and a second RS for IBP 1110. Each of the RSs for IBP includes a first part and a second part. The first part may include, for example, a scrambling identifier that maps to 3 destination identifiers, and the second part may include a scrambling identifier that maps to 1 of the 3 destination identifiers. In some aspects, the first part may be associated with a number of destination identifiers, and each destination identifier may map to one of a number of hypotheses that can be used to sense the RS for IBP. Other transmit UEs (e.g., first UEs) may sense the RS for IBP 1105 using at least the first part. Other transmit UEs may sense a resource conflict according to a number of hypotheses associated with the first part. For example, a resource associated with a larger number of hypotheses may be associated with a higher level of conflict than a resource associated with a smaller number of hypotheses. The first RS for IBP 1105 may be transmitted using a first beam and the second RS for IBP 1110 may be transmitted using a second beam different than the first beam. In some aspects, the first part may include a primary sidelink synchronization signal (P-SSS), a secondary sidelink synchronization signal (S-SSS), or a sidelink CSI-RS that has a first number of hypotheses over all destination identifiers. In some aspects, the second part may include an S-SSS or a sidelink CSI-RS that is based on a unique scrambling identifier for each destination identifier associated with the first part.

As indicated above, FIGS. 6-11 are provided as examples. Other examples may differ from what is described with regard to FIGS. 6-11.

FIG. 12 is a diagram illustrating an example process 1200 performed, for example, at a UE or an apparatus of a UE, in accordance with the present disclosure. Example process 1200 is an example where the apparatus or the UE (e.g., UE 120) performs operations associated with reference signaling for initial beam-pairing with resource coordination among UEs.

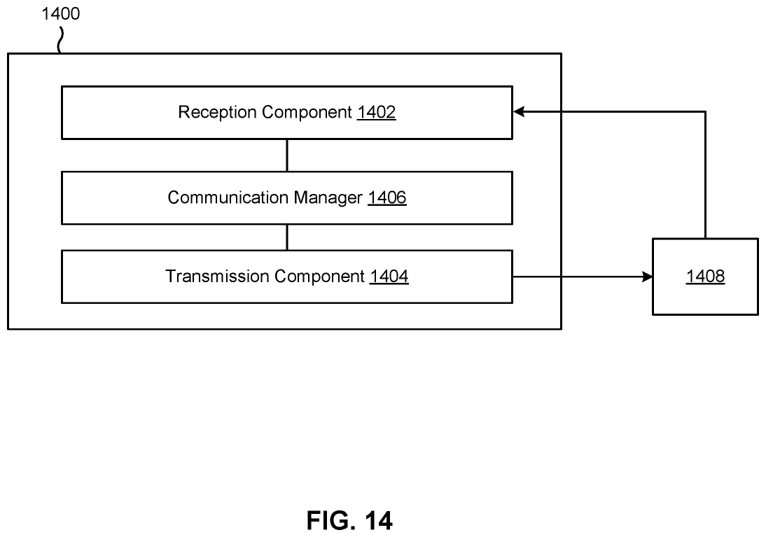

As shown in FIG. 12, in some aspects, process 1200 may include transmitting an RS for IBP on an IBP-RS resource specific to transmission of the RS for IBP (block 1210). For example, the UE (e.g., using transmission component 1404 and/or communication manager 1406, depicted in FIG. 14) may transmit an RS for IBP on an IBP-RS resource specific to transmission of the RS for IBP, as described above.

As further shown in FIG. 12, in some aspects, process 1200 may include receiving, from a second UE, a beam-pairing response associated with the RS for IBP (block 1220). For example, the UE (e.g., using reception component 1402 and/or communication manager 1406, depicted in FIG. 14) may receive, from a second UE, a beam-pairing response associated with the RS for IBP, as described above.

Process 1200 may include additional aspects, such as any single aspect or any combination of aspects described below and/or in connection with one or more other processes described elsewhere herein.

In a first aspect, the IBP-RS resource corresponds to a sidelink resource pool that indicates IBP-RS resources.

In a second aspect, alone or in combination with the first aspect, process 1200 includes receiving configuration information indicating the sidelink resource pool.

In a third aspect, alone or in combination with one or more of the first and second aspects, the sidelink resource pool indicates one or more candidate IBP-RS resources, and process 1200 includes selecting the IBP-RS resource from the one or more candidate IBP-RS resources.

In a fourth aspect, alone or in combination with one or more of the first through third aspects, the IBP-RS resource is one of one or more candidate IBP-RS resources.

In a fifth aspect, alone or in combination with one or more of the first through fourth aspects, the one or more candidate IBP-RS resources are mapped to an identifier.

In a sixth aspect, alone or in combination with one or more of the first through fifth aspects, the identifier is a destination identifier associated with a unicast link establishment or a sidelink service identifier.

In a seventh aspect, alone or in combination with one or more of the first through sixth aspects, process 1200 includes selecting the IBP-RS resource from the one or more candidate IBP-RS resources based at least in part on at least one of a random selection, or a sensing-based selection.

In an eighth aspect, alone or in combination with one or more of the first through seventh aspects, process 1200 includes selecting the IBP-RS resource based at least in part on measuring the one or more candidate IBP-RS resources.

In a ninth aspect, alone or in combination with one or more of the first through eighth aspects, transmitting the RS for IBP further comprises transmitting the RS for IBP using a scrambling identifier derived from a destination identifier.

In a tenth aspect, alone or in combination with one or more of the first through ninth aspects, the scrambling identifier has at least 28 potential values.

In an eleventh aspect, alone or in combination with one or more of the first through tenth aspects, the RS for IBP includes a first part and a second part, wherein the first part is associated with a first set of identifiers and the second part is associated with a second set of identifiers.

In a twelfth aspect, alone or in combination with one or more of the first through eleventh aspects, the first part occupies at least one of a different time-domain resource than the second part, or a different frequency-domain resource than the second part.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram illustrating an example process 1300 performed, for example, at a second UE or an apparatus of a second UE, in accordance with the present disclosure. Example process 1300 is an example where the apparatus or the second UE (e.g., UE 120) performs operations associated with reference signaling for IBP with resource coordination among UEs.

As shown in FIG. 13, in some aspects, process 1300 may include receiving an RS for IBP on an IBP-RS resource specific to transmission of the RS for IBP (block 1310). For example, the UE (e.g., using reception component 1402 and/or communication manager 1406, depicted in FIG. 14) may receive an RS for IBP on an IBP-RS resource specific to transmission of the RS for IBP, as described above.

As further shown in FIG. 13, in some aspects, process 1300 may include transmitting, to a first UE, a beam-pairing response associated with the RS for IBP (block 1320). For example, the UE (e.g., using transmission component 1404 and/or communication manager 1406, depicted in FIG. 14) may transmit, to a first UE, a beam-pairing response associated with the RS for IBP, as described above.

Process 1300 may include additional aspects, such as any single aspect or any combination of aspects described below and/or in connection with one or more other processes described elsewhere herein.

In a first aspect, the IBP-RS resource corresponds to a sidelink resource pool that indicates IBP-RS resources.

In a second aspect, alone or in combination with the first aspect, process 1300 includes receiving configuration information indicating the sidelink resource pool.

In a third aspect, alone or in combination with one or more of the first and second aspects, the sidelink resource pool indicates one or more candidate IBP-RS resources.

In a fourth aspect, alone or in combination with one or more of the first through third aspects, the IBP-RS resource is one of one or more candidate IBP-RS resources, wherein receiving the RS for IBP further comprises attempting to receive the RS for IBP on the one or more candidate IBP-RS resources.

In a fifth aspect, alone or in combination with one or more of the first through fourth aspects, the one or more candidate IBP-RS resources are mapped to an identifier, wherein attempting to receive the RS for IBP on the one or more candidate IBP-RS resources is based at least in part on the one or more candidate IBP-RS resources being mapped to the identifier.

In a sixth aspect, alone or in combination with one or more of the first through fifth aspects, the destination identifier is associated with a unicast link establishment.

In a seventh aspect, alone or in combination with one or more of the first through sixth aspects, receiving the RS for IBP further comprises receiving the RS for IBP using a scrambling identifier derived from a destination identifier.

In an eighth aspect, alone or in combination with one or more of the first through seventh aspects, the scrambling identifier has at least 28 potential values.

In a ninth aspect, alone or in combination with one or more of the first through eighth aspects, the RS for IBP includes a first part and a second part, wherein the first part is associated with multiple destination identifiers and the second part is associated with a single destination identifier.

In a tenth aspect, alone or in combination with one or more of the first through ninth aspects, the first part occupies at least one of a different time-domain resource than the second part, or a different frequency-domain resource than the second part.

In an eleventh aspect, alone or in combination with one or more of the first through tenth aspects, receiving the RS for IBP further comprises measuring the second part of the RS for IBP.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a diagram of an example apparatus 1400 for wireless communication, in accordance with the present disclosure. The apparatus 1400 may be a first UE, or a first UE may include the apparatus 1400. In some aspects, the apparatus 1400 includes a reception component 1402, a transmission component 1404, and/or a communication manager 1406, which may be in communication with one another (for example, via one or more buses and/or one or more other components). In some aspects, the communication manager 1406 is the communication manager 140 described in connection with FIG. 1. As shown, the apparatus 1400 may communicate with another apparatus 1408, such as a UE or a network node (such as a CU, a DU, an RU, or a base station), using the reception component 1402 and the transmission component 1404.

In some aspects, the apparatus 1400 may be configured to perform one or more operations described herein in connection with FIGS. 3-11. Additionally, or alternatively, the apparatus 1400 may be configured to perform one or more processes described herein, such as process 1200 of FIG. 12, or a combination thereof. In some aspects, the apparatus 1400 and/or one or more components shown in FIG. 14 may include one or more components of the first UE described in connection with FIG. 2. Additionally, or alternatively, one or more components shown in FIG. 14 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1402 may receive communications, such as reference signals, control information, data communications, or a combination thereof, from the apparatus 1408. The reception component 1402 may provide received communications to one or more other components of the apparatus 1400. In some aspects, the reception component 1402 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1400. In some aspects, the reception component 1402 may include one or more antennas, one or more modems, one or more demodulators, one or more MIMO detectors, one or more receive processors, one or more controllers/processors, one or more memories, or a combination thereof, of the first UE described in connection with FIG. 2.

The transmission component 1404 may transmit communications, such as reference signals, control information, data communications, or a combination thereof, to the apparatus 1408. In some aspects, one or more other components of the apparatus 1400 may generate communications and may provide the generated communications to the transmission component 1404 for transmission to the apparatus 1408. In some aspects, the transmission component 1404 may perform signal processing on the generated communications (such as filtering, amplification, modulation, digital-to-analog conversion, multiplexing, interleaving, mapping, or encoding, among other examples), and may transmit the processed signals to the apparatus 1408. In some aspects, the transmission component 1404 may include one or more antennas, one or more modems, one or more modulators, one or more transmit MIMO processors, one or more transmit processors, one or more controllers/processors, one or more memories, or a combination thereof, of the first UE described in connection with FIG. 2. In some aspects, the transmission component 1404 may be co-located with the reception component 1402 in one or more transceivers.

The communication manager 1406 may support operations of the reception component 1402 and/or the transmission component 1404. For example, the communication manager 1406 may receive information associated with configuring reception of communications by the reception component 1402 and/or transmission of communications by the transmission component 1404. Additionally, or alternatively, the communication manager 1406 may generate and/or provide control information to the reception component 1402 and/or the transmission component 1404 to control reception and/or transmission of communications.

The transmission component 1404 may transmit an RS for IBP on an IBP-RS resource specific to transmission of the RS for IBP. The reception component 1402 may receive, from a second UE, a beam-pairing response associated with the RS for IBP.

The reception component 1402 may receive configuration information indicating the sidelink resource pool.

The communication manager 1406 may select the IBP-RS resource from the one or more candidate IBP-RS resources based at least in part on at least one of a random selection, or a sensing-based selection.

The communication manager 1406 may select the IBP-RS resource based at least in part on measuring the one or more candidate IBP-RS resources.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

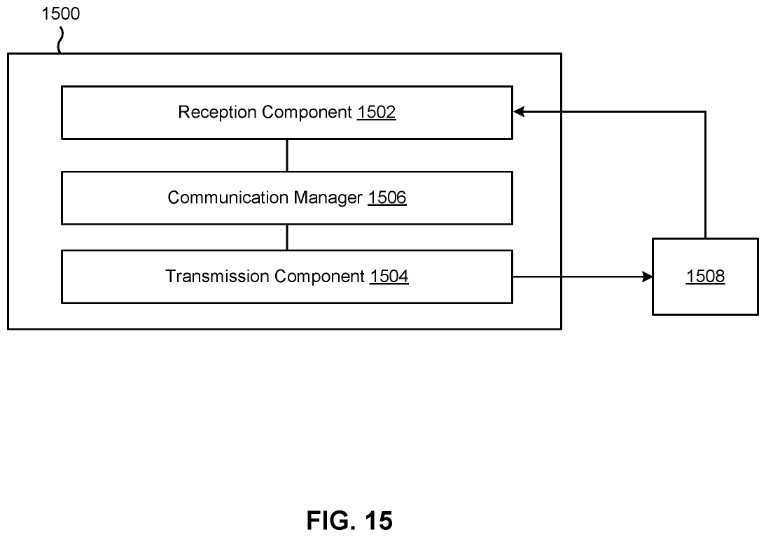

FIG. 15 is a diagram of an example apparatus 1500 for wireless communication, in accordance with the present disclosure. The apparatus 1500 may be a second UE, or a second UE may include the apparatus 1500. In some aspects, the apparatus 1500 includes a reception component 1502, a transmission component 1504, and/or a communication manager 1506, which may be in communication with one another (for example, via one or more buses and/or one or more other components). In some aspects, the communication manager 1506 is the communication manager 140 described in connection with FIG. 1. As shown, the apparatus 1500 may communicate with another apparatus 1508, such as a UE or a network node (such as a CU, a DU, an RU, or a base station), using the reception component 1502 and the transmission component 1504.

In some aspects, the apparatus 1500 may be configured to perform one or more operations described herein in connection with FIGS. 3-11. Additionally, or alternatively, the apparatus 1500 may be configured to perform one or more processes described herein, such as process 1300 of FIG. 13, or a combination thereof. In some aspects, the apparatus 1500 and/or one or more components shown in FIG. 15 may include one or more components of the second user equipment (UE) described in connection with FIG. 2. Additionally, or alternatively, one or more components shown in FIG. 15 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1502 may receive communications, such as reference signals, control information, data communications, or a combination thereof, from the apparatus 1508. The reception component 1502 may provide received communications to one or more other components of the apparatus 1500. In some aspects, the reception component 1502 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1500. In some aspects, the reception component 1502 may include one or more antennas, one or more modems, one or more demodulators, one or more MIMO detectors, one or more receive processors, one or more controllers/processors, one or more memories, or a combination thereof, of the second UE described in connection with FIG. 2.

The transmission component 1504 may transmit communications, such as reference signals, control information, data communications, or a combination thereof, to the apparatus 1508. In some aspects, one or more other components of the apparatus 1500 may generate communications and may provide the generated communications to the transmission component 1504 for transmission to the apparatus 1508. In some aspects, the transmission component 1504 may perform signal processing on the generated communications (such as filtering, amplification, modulation, digital-to-analog conversion, multiplexing, interleaving, mapping, or encoding, among other examples), and may transmit the processed signals to the apparatus 1508. In some aspects, the transmission component 1504 may include one or more antennas, one or more modems, one or more modulators, one or more transmit MIMO processors, one or more transmit processors, one or more controllers/processors, one or more memories, or a combination thereof, of the second user equipment (UE) described in connection with FIG. 2. In some aspects, the transmission component 1504 may be co-located with the reception component 1502 in one or more transceivers.

The communication manager 1506 may support operations of the reception component 1502 and/or the transmission component 1504. For example, the communication manager 1506 may receive information associated with configuring reception of communications by the reception component 1502 and/or transmission of communications by the transmission component 1504. Additionally, or alternatively, the communication manager 1506 may generate and/or provide control information to the reception component 1502 and/or the transmission component 1504 to control reception and/or transmission of communications.

The reception component 1502 may receive an RS for IBP on an IBP-RS resource specific to transmission of the RS for IBP. The transmission component 1504 may transmit, to a first UE, a beam-pairing response associated with the RS for IBP.

The reception component 1502 may receive configuration information indicating the sidelink resource pool.

The number and arrangement of components shown in FIG. 15 are provided as an example. In practice, there may be additional components, fewer components, different components, or differently arranged components than those shown in FIG. 15. Furthermore, two or more components shown in FIG. 15 may be implemented within a single component, or a single component shown in FIG. 15 may be implemented as multiple, distributed components. Additionally, or alternatively, a set of (one or more) components shown in FIG. 15 may perform one or more functions described as being performed by another set of components shown in FIG. 15.

The following provides an overview of some Aspects of the present disclosure:

Aspect 1: A method of wireless communication performed by a first user equipment (UE), comprising: transmitting a reference signal (RS) for initial beam-pairing (IBP) on an IBP-RS resource specific to transmission of the RS for IBP; and receiving, from a second UE, a beam-pairing response associated with the RS for IBP.

Aspect 2: The method of Aspect 1, wherein the IBP-RS resource corresponds to a sidelink resource pool that indicates IBP-RS resources.

Aspect 3: The method of Aspect 2, further comprising receiving configuration information indicating the sidelink resource pool.

Aspect 4: The method of Aspect 2, wherein the sidelink resource pool indicates one or more candidate IBP-RS resources, wherein the method further comprises selecting the IBP-RS resource from the one or more candidate IBP-RS resources.

Aspect 5: The method of any of Aspects 1-4, wherein the IBP-RS resource is one of one or more candidate IBP-RS resources.

Aspect 6: The method of Aspect 5, wherein the one or more candidate IBP-RS resources are mapped to an identifier indicating the one or more candidate IBP-RS resources from a plurality of IBP-RS resources, and wherein selecting the IBP-RS resource further comprises selecting the IBP-RS resource from the one or more candidate IBP-RS resources based at least in part on the identifier.

Aspect 7: The method of Aspect 6, wherein the identifier is a destination identifier associated with a unicast link establishment or a sidelink service identifier.

Aspect 8: The method of Aspect 5, further comprising selecting the IBP-RS resource from the one or more candidate IBP-RS resources based at least in part on at least one of: a random selection, or a sensing-based selection.

Aspect 9: The method of Aspect 5, further comprising selecting the IBP-RS resource based at least in part on measuring the one or more candidate IBP-RS resources.

Aspect 10: The method of any of Aspects 1-9, wherein transmitting the RS for IBP further comprises transmitting the RS for IBP using a scrambling identifier derived from a destination identifier.

Aspect 11: The method of Aspect 10, wherein the scrambling identifier has at least 28 potential values.

Aspect 12: The method of any of Aspects 1-11, wherein the RS for IBP includes a first part and a second part, wherein the first part is associated with a first resource or a first scrambling identifier derived from a first set of identifiers and the second part is associated with a second resource or a second scrambling identifier derived from a second set of identifiers, wherein the first set of identifiers includes a larger number of identifiers than the second set of identifiers.

Aspect 13: The method of Aspect 12, wherein the first part occupies at least one of: a different time-domain resource than the second part, or a different frequency-domain resource than the second part.

Aspect 14: A method of wireless communication performed by a second user equipment (UE), comprising: receiving a reference signal (RS) for initial beam-pairing (IBP) on an IBP-RS resource specific to transmission of the RS for IBP; and transmitting, to a first UE, a beam-pairing response associated with the RS for IBP.

Aspect 15: The method of Aspect 14, wherein the IBP-RS resource corresponds to a sidelink resource pool that indicates IBP-RS resources.

Aspect 16: The method of Aspect 15, further comprising receiving configuration information indicating the sidelink resource pool.

Aspect 17: The method of Aspect 15, wherein the sidelink resource pool indicates one or more candidate IBP-RS resources.

Aspect 18: The method of any of Aspects 14-17, wherein the IBP-RS resource is one of one or more candidate IBP-RS resources, wherein receiving the RS for IBP further comprises attempting to receive the RS for IBP on the one or more candidate IBP-RS resources.

Aspect 19: The method of Aspect 18, wherein the one or more candidate IBP-RS resources are mapped to an identifier indicating the one or more candidate IBP-RS resources from a plurality of IBP-RS resources, wherein attempting to receive the RS for IBP on the one or more candidate IBP-RS resources is based at least in part on the one or more candidate IBP-RS resources being mapped to the identifier.

Aspect 20: The method of Aspect 19, wherein the destination identifier is associated with a unicast link establishment.

Aspect 21: The method of any of Aspects 14-20, wherein receiving the RS for IBP further comprises receiving the RS for IBP using a scrambling identifier derived from a destination identifier.

Aspect 22: The method of Aspect 21, wherein the scrambling identifier has at least 28 potential values.

Aspect 23: The method of any of Aspects 14-22, wherein the first part uses a first resource or a first scrambling identifier derived from multiple destination identifiers and the second part uses a second resource or a second scrambling identifier derived from a single destination identifier associated with the second UE.

Aspect 24: The method of Aspect 23, wherein the first part occupies at least one of: a different time-domain resource than the second part, or a different frequency-domain resource than the second part.

Aspect 25: The method of Aspect 23, wherein receiving the RS for IBP further comprises measuring the second part of the RS for IBP.

Aspect 26: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-25.

Aspect 27: An apparatus for wireless communication at a device, the apparatus comprising one or more memories and one or more processors coupled to the one or more memories, the one or more processors configured to cause the device to perform the method of one or more of Aspects 1-25.

Aspect 28: An apparatus for wireless communication, the apparatus comprising at least one means for performing the method of one or more of Aspects 1-25.

Aspect 29: A non-transitory computer-readable medium storing code for wireless communication, the code comprising instructions executable by one or more processors to perform the method of one or more of Aspects 1-25.

Aspect 30: A non-transitory computer-readable medium storing a set of instructions for wireless communication, the set of instructions comprising one or more instructions that, when executed by one or more processors of a device, cause the device to perform the method of one or more of Aspects 1-25.

Aspect 31: A device for wireless communication, the device comprising a processing system that includes one or more processors and one or more memories coupled with the one or more processors, the processing system configured to cause the device to perform the method of one or more of Aspects 1-25.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware, firmware, or a combination of hardware and software. As used herein, a processor is implemented in hardware, firmware, or a combination of hardware and software. As used herein, the phrase “based on” is intended to be broadly construed to mean “based at least in part on.” As used herein, “satisfying a threshold” may, depending on the context, refer to a value being greater than the threshold, greater than or equal to the threshold, less than the threshold, less than or equal to the threshold, equal to the threshold, or not equal to the threshold, among other examples. As used herein, a phrase referring to “at least one of” a list of items refers to any combination of those items, including single members. As an example, “at least one of: a, b, or c” is intended to cover: a, b, c, a+b, a+c, b+c, and a+b+c.

Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (for example, related items, unrelated items, or a combination of related and unrelated items), and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A also may have B). Further, as used herein, the term “or” is intended to be inclusive when used in a series and may be used interchangeably with “and/or,” unless explicitly stated otherwise (for example, if used in combination with “either” or “only one of”).

The various illustrative logics, logical blocks, modules, circuits and algorithm processes described in connection with the aspects disclosed herein may be implemented as electronic hardware, computer software, or combinations of both. The interchangeability of hardware and software has been described generally, in terms of functionality, and illustrated in the various illustrative components, blocks, modules, circuits and processes described herein. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Aspects of the subject matter described in this specification also can be implemented as one or more computer programs (such as one or more modules of computer program instructions) encoded on a computer storage media for execution by, or to control the operation of, a data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the media described herein should also be included within the scope of computer-readable media. Additionally, the operations of a method or algorithm may reside as one or any combination or set of codes and instructions on a machine readable medium and computer-readable medium, which may be incorporated into a computer program product.

Various modifications to the aspects described in this disclosure may be readily apparent to those skilled in the art, and the generic principles defined herein may be applied to other aspects without departing from the spirit or scope of this disclosure. Thus, the claims are not intended to be limited to the aspects shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate aspects also can be implemented in combination in a single aspect. Conversely, various features that are described in the context of a single aspect also can be implemented in multiple aspects separately or in any suitable subcombination. Moreover, although features may be described as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the aspects described should not be understood as requiring such separation in all aspects, and it should be understood that the described program components and systems can generally be integrated together in a single software product or packaged into multiple software products. Additionally, other aspects are within the scope of the following claims. In some cases, the actions recited in the claims can be performed in a different order and still achieve desirable results.

What is claimed is:

1. An apparatus for wireless communication at a first user equipment (UE), comprising:
one or more memories; and
one or more processors, coupled to the one or more memories, individually or collectively configured to cause the first UE to:
transmit a reference signal (RS) for initial beam-pairing (IBP) on an IBP-RS resource specific to transmission of the RS for IBP; and
receive, from a second UE, a beam-pairing response associated with the RS for IBP.

2. The apparatus of claim 1, wherein the IBP-RS resource corresponds to a sidelink resource pool that indicates IBP-RS resources.

3. The apparatus of claim 2, wherein the one or more processors are further individually or collectively configured to cause the first UE to receive configuration information indicating the sidelink resource pool.

4. The apparatus of claim 2, wherein the sidelink resource pool indicates one or more candidate IBP-RS resources,
wherein the one or more processors are further individually or collectively configured to cause the first UE to select the IBP-RS resource from the one or more candidate IBP-RS resources.

5. The apparatus of claim 1, wherein the IBP-RS resource is one of one or more candidate IBP-RS resources.

6. The apparatus of claim 5, wherein the one or more candidate IBP-RS resources are mapped to an identifier indicating the one or more candidate IBP-RS resources from a plurality of IBP-RS resources, and wherein selecting the IBP-RS resource further comprises selecting the IBP-RS resource from the one or more candidate IBP-RS resources based at least in part on the identifier.

7. The apparatus of claim 6, wherein the identifier is a destination identifier associated with a unicast link establishment or a sidelink service identifier.

8. The apparatus of claim 5, wherein the one or more processors are individually or collectively configured to cause the first UE to select the IBP-RS resource from the one or more candidate IBP-RS resources based at least in part on at least one of:
a random selection, or
a sensing-based selection.

9. The apparatus of claim 5, wherein the one or more processors are individually or collectively configured to cause the first UE to select the IBP-RS resource based at least in part on measuring the one or more candidate IBP-RS resources.

10. The apparatus of claim 1, wherein the one or more processors, to cause the first UE to transmit the RS for IBP, are individually or collectively configured to cause the first UE to transmit the RS for IBP using a scrambling identifier derived from a destination identifier.

11. The apparatus of claim 10, wherein the scrambling identifier has at least 28 potential values.

12. The apparatus of claim 1, wherein the RS for IBP includes a first part and a second part, wherein the first part is associated with a first resource or a first scrambling identifier derived from a first set of identifiers and the second part is associated with a second resource or a second scrambling identifier derived from a second set of identifiers, wherein the first set of identifiers includes a larger number of identifiers than the second set of identifiers.

13. The apparatus of claim 12, wherein the first part occupies at least one of:
a different time-domain resource than the second part, or
a different frequency-domain resource than the second part.

14. An apparatus for wireless communication at a second user equipment (UE), comprising:
one or more memories; and
one or more processors, coupled to the one or more memories, individually or collectively configured to cause the second UE to:
receive a reference signal (RS) for initial beam-pairing (IBP) on an IBP-RS resource specific to transmission of the RS for IBP; and
transmit, to a first UE, a beam-pairing response associated with the RS for IBP.

15. The apparatus of claim 14, wherein the IBP-RS resource corresponds to a sidelink resource pool that indicates IBP-RS resources.

16. The apparatus of claim 15, wherein the one or more processors are individually or collectively configured to cause the second UE to receive configuration information indicating the sidelink resource pool.

17. The apparatus of claim 15, wherein the sidelink resource pool indicates one or more candidate IBP-RS resources.

18. The apparatus of claim 14, wherein the IBP-RS resource is one of one or more candidate IBP-RS resources, wherein the one or more processors, to cause the second UE to receive the RS for IBP, are individually or collectively configured to cause the second UE to attempt to receive the RS for IBP on the one or more candidate IBP-RS resources.

19. The apparatus of claim 18, wherein the one or more candidate IBP-RS resources are mapped to an identifier indicating the one or more candidate IBP-RS resources from a plurality of IBP-RS resources, wherein the one or more processors, to cause the second UE to attempt to receive the RS for IBP on the one or more candidate IBP-RS resources, are individually or collectively configured to cause the second UE to attempt to receive the RS for IBP based at least in part on the one or more candidate IBP-RS resources being mapped to the identifier.

20. The apparatus of claim 19, wherein the identifier is associated with a unicast link establishment.

21. The apparatus of claim 14, wherein the one or more processors, to cause the second UE to receive the RS for IBP, are configured to cause the second UE to receive the RS for IBP using a scrambling identifier derived from a destination identifier.

22. The apparatus of claim 21, wherein the scrambling identifier has at least 28 potential values.

23. The apparatus of claim 14, wherein the RS for IBP includes a first part and a second part, wherein the first part uses a first resource or a first scrambling identifier derived from multiple destination identifiers and the second part uses a second resource or a second scrambling identifier derived from a single destination identifier associated with the second UE.

24. The apparatus of claim 23, wherein the first part occupies at least one of:
a different time-domain resource than the second part, or
a different frequency-domain resource than the second part.

25. The apparatus of claim 23, wherein the one or more processors, to cause the second UE to receive the RS for IBP, are individually or collectively configured to cause the second UE to measure the second part of the RS for IBP using the single destination identifier.

26. The apparatus of claim 23, wherein the first part occupies at least one of:
a different time-domain resource than the second part, or
a different frequency-domain resource than the second part.

27. The apparatus of claim 23, wherein the one or more processors, to cause the second UE to receive the RS for IBP, are individually or collectively configured to cause the second UE to measure the second part of the RS for IBP.

28. A method of wireless communication performed by a first user equipment (UE), comprising:
transmitting a reference signal (RS) for initial beam-pairing (IBP) on an IBP-RS resource specific to transmission of the RS for IBP; and
receiving, from a second UE, a beam-pairing response associated with the RS for IBP.

29. The method of claim 28, wherein the IBP-RS resource corresponds to a sidelink resource pool that indicates IBP-RS resources.

30. A method of wireless communication performed by a second user equipment (UE), comprising:
receiving a reference signal (RS) for initial beam-pairing (IBP) on an IBP-RS resource specific to transmission of the RS for IBP; and
transmitting, to a first UE, a beam-pairing response associated with the RS for IBP.
